(19) United States
(12) Patent Application Publication
(10) Pub. No.: US 2017/0062868 A1
(43) Pub. Date: Mar. 2, 2017

(54) SODIUM SECONDARY BATTERY

(71) Applicant: SUMITOMO CHEMICAL COMPANY, LIMITED, Tokyo (JP)

(72) Inventor: Jun-ichi KAGEURA, Tsukuba-shi (JP)

(73) Assignee: SUMITOMO CHEMICAL COMPANY, LIMITED, Tokyo (JP)

(21) Appl. No.: 15/119,926

(22) PCT Filed: Feb. 9, 2015
(86) PCT No.: PCT/JP2015/054502

§ 371 Date: Aug. 18, 2016

(30) Foreign Application Priority Data
Feb. 21, 2014 (JP) 2014-031640

(51) Int. Cl. H01M 10/054; H01M 10/0567; H01M 4/587; H01M 10/0569; H01M 4/505; H01M 4/525

(52) U.S. Cl. CPC H01M 10/054; H01M 4/505; H01M 4/525; H01M 4/587; H01M 10/0569; H01M 10/0567

(57) ABSTRACT

To provide a sodium secondary battery including a positive electrode having a positive electrode active material that can be doped and undoped with sodium ions, a negative electrode having a negative electrode active material that can be doped and undoped with sodium ions, and an electrolyte solution containing a solvent, a sodium salt and a polymer compound, wherein the electrolyte solution contains the polymer compound in an amount ranging from 0.1% by weight to 18% by weight inclusive, in the electrolyte solution.

### CROSS REFERENCE TO RELATED APPLICATIONS

This application is a National Stage of International Application No. PCT/JP2015/054502 filed Feb. 9, 2015, claiming priority based on Japanese Patent Application No. 2014-031640, filed Feb. 21, 2014, the contents of which are incorporated herein by reference in their entirety.

### TECHNICAL FIELD

The present invention relates to a sodium secondary battery.

### BACKGROUND ART

Since sodium has the large quantity resources and is a low-price material, it is expected that a large power sources is supplied by putting a sodium secondary battery into practice.

Normally, a sodium secondary battery has at least one pair of electrodes composed of a positive electrode containing a positive electrode active material that is doped and undoped with sodium ions, a negative electrode containing a negative electrode active material that is doped and undoped with sodium ions, and an electrolyte.

As an electrolyte solution used in a sodium secondary battery, There has been studied a sodium secondary battery which employs an electrolyte solution in which an electrolyte salt including sodium hexafluorophosphate is dissolved in a solvent including a saturated cyclic carbonic acid ester such as propylene carbonate (Patent Document 1).

### PRIOR ART DOCUMENT

### Patent Document

Patent Document 1: JP-A-2007-35283

### SUMMARY OF THE INVENTION

### Problem to be Solved by the Invention

The aforementioned sodium secondary battery, however, is not necessarily satisfactory with respect to output characteristics. Therefore, it is an object of the present invention to provide a sodium secondary battery having excellent output characteristics.

### Means for Solving the Problem

For achieving the aforementioned object, there is provided a sodium secondary battery including a positive electrode having a positive electrode active material that is doped and undoped with sodium ions, a negative electrode having a negative electrode active material that is doped and undoped with sodium ions, and an electrolyte solution containing a solvent, a sodium salt and a polymer compound, wherein the electrolyte solution contains the polymer compound in an amount ranging from 0.1% by weight to 18% by weight to the electrolyte solution.

### Effect of the Invention

According to the present invention, it is possible to provide a sodium secondary battery having excellent output characteristics without changing the composition of the solvent in the electrolyte solution, and thus the present invention is industrially very useful.

### MODE FOR CARRYING OUT THE INVENTION

### Sodium Secondary Battery

The sodium secondary battery of the present invention has a positive electrode having a positive electrode active material that is doped and undoped with sodium ions, a negative electrode having a negative electrode active material that is doped and undoped with sodium ions, and an electrolyte solution, and usually further has a separator.

A sodium secondary battery can usually be produced by storing a laminate of a negative electrode, a separator and positive electrode, or an electrode group obtained by winding or folding the laminate, in a battery can or an aluminum laminate pack, and immersing the electrode group with an electrolyte solution.

A shape of an electrode group includes, for example, a shape such that the cross section when the electrode group is cut in the direction perpendicular to the axis of the winding has a circle, an ellipse, a rectangular shape, or a rectangular shape without sharp edges. Examples of the shape of the battery include a paper shape, a coin shape, a cylindrical shape or a rectangular prism shape.

In particular, in a paper-shaped battery or in a rectangular prism-shaped battery using an aluminum laminate pack, a pressing process such as pressing is occasionally conducted in the direction perpendicular to the electrode surface after production from the viewpoint of fixing a shape.

### <Electrolyte Solution>

The electrolyte solution used in the sodium secondary battery of the present invention contains a solvent, a sodium salt and a polymer compound. As the electrolyte solution, a nonaqueous electrolyte solution using a nonaqueous solvent as a solvent is preferred.

The electrolyte solution may be in a solution state (sol state), or may be in a gel state with poor fluidity. Also both of the sol state and the gel state may coexist. Examples the gel include chemically-crosslinked gel and/or physically-crosslinked gel.

### <Sodium Salt>

Examples of the sodium salt used in the electrolyte solution include NaPF₆, NaBF₄, NaClO₄, NaN(SO₂CF₃)₂, NaN(SO₂C₂F₅)₂, NaCF₃SO₃, NaAsF₆, NaSbF₆, NaBC₄O₈, lower aliphatic carboxylic acid sodium salt, NaAlCl₄NaPO₂F₂, and Na₂PO₃F, and two or more of these may be used. Among these, it is preferred to use a fluorine atom-containing sodium salt containing at least one selected from the group consisting of NaPF₆, NaBF₄, NaSbF₆, NaN(SO₂CF₃)₂, NaN(SO₂C₂F₅)₂, NaCF₃SO₃ and NaN(SO₂CF₃)₂, and Na₂PO₃F, and it is more preferred to use a fluorine atom-containing sodium salt containing at least one selected from the group consisting of NaPF₆, NaBF₄, and NaN(SO₂CF₃)₂.

The sodium salt in the electrolyte solution may partly remain undissolved, or entirely dissolved. Regarding the sodium salt in the electrolyte solution, from the view point of conductivity, the sodium salt is contained in a ratio of preferably 0.5 mol or more, more preferably 0.7 mol or more, further preferably 0.8 mol or more with respect to 1 L of the electrolyte solution. From the view point of the dissolubility of the sodium salt in the electrolyte solution, the sodium salt is contained in a ratio of preferably 3.0 mol or less, more preferably 2.5 mol or less, further preferably 2.0 mol or less, particularly preferably 1.5 mol or less with respect to 1 L of the electrolyte solution.

### <Solvent>

In the present invention, as the solvent used in the electrolyte solution, a nonaqueous solvent is preferred, and examples of the nonaqueous solvent that can be used include cyclic carbonic esters such as propylene carbonate, ethylene carbonate, fluoroethylene carbonate, and difluoroethylene carbonate; chain carbonic esters such as dimethyl carbonate, diethyl carbonate, and ethylmethyl carbonate; ethers such as 1,2-dimethoxyethane, 1,3-dimethoxypropane, pentafluoropropylmethyl ether, 2,2,3,3-tetrafluoropropyldifluoromethyl ether, tetrahydrofuran, and 2-methyltetrahydrofuran; esters such as methyl formate, and methyl acetate; lactones such as γ-butyrolactone, γ-valerolactone, δ-valerolactone, and ε-caprolactone; nitriles such as acetonitrile, and butyronitrile; amides such as N,N-dimethylformamide, N,N-dimethylacetamide, and 1,3-dimethyl-2-imidazolidinone; carbamates such as 3-methyl-2-oxazolidone; and sulfur-containing compounds such as dimethyl sulfate, dimethylsulphite, dipropyl sulphite, ethylene sulphite, dimethyl sulfone, ethylmethyl sulfone, diphenyl sulfone, sulfolane, methyl methanesulfonate, dimethyl sulfoxide, and 1,3-propane sultone. As a nonaqueous solvent, two of more of these may be mixed and used.

The nonaqueous solvent used in the electrolyte solution preferably contains at least one selected from the group consisting of ethylene carbonate, propylene carbonate, sulfolane, γ-butyrolactone, and fluoroethylene carbonate, and more preferably, contains ethylene carbonate and/or propylene carbonate, and further preferably contains propylene carbonate.

Ethylene carbonate, propylene carbonate, sulfolane, gamma butyrolactone and fluoroethylene carbonate are highly dielectric nonaqueous solvents, and with using the highly dielectric nonaqueous solvent, dissolubility of the polymer compound contained in the electrolyte solution is improved. From the viewpoint of the dissolubility of the polymer compound, the highly dielectric nonaqueous solvent is preferably 40% by weight or more, more preferably 50% by weight or more, further preferably 60% by weight or more, particularly preferably 70% by weight or more with respect to the electrolyte solution. Also from the view point of the wettability of the electrolyte solution to the separator, the highly dielectric nonaqueous solvent is preferably 90% by weight or less.

### <Polymer Compound>

The content of the polymer compound in the electrolyte solution is 18% by weight or less, preferably 13% by weight or less, more preferably 9% by weight or less, further preferably 5% by weight or less from the viewpoint of impregnating ability of the electrolyte solution into the electrodes. Also, from the view point of enhancing the output characteristics, the content of the polymer compound is 0.1% by weight or more, preferably 0.4% by weight or more, more preferably 1.0% by weight or more, particularly preferably 2.2% by weight or more with respect to the electrolyte solution.

Preferably, the polymer compound contains at least one structural unit selected from the group consisting of the following formulas (A) to (D):

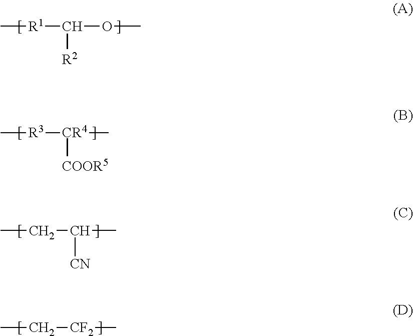

(wherein, R¹ and R³ each independently represents an optionally substituted alkylene group having 1 to 20 carbon atoms, R² and R⁴ each independently represents a hydrogen atom, a hydroxyl group, an optionally substituted alkyl group having 1 to 20 carbon atoms, or an optionally substituted C1 to C20 alkoxy group, and R⁵ represents a hydrogen atom or an optionally substituted alkyl group having 1 to 20 carbon atoms.)

The R¹ and R³ each represents an optionally substituted alkylene group having 1 to 20 carbon atoms, and preferably a group represented by —CH₂— or —C₂H₄—, more preferably a group represented by —CH₂—.

The R² and R⁴ each represents a hydrogen atom (—H), a hydroxyl group (—OH), an optionally substituted alkyl group or an optionally substituted alkoxy group, preferably a hydrogen atom or a group represented by —CH₃, —C₂H₅, —C₃H₇, —C₄H₉, —OCH₃, —OC₂H₅, —OC₃H₇, —OC₄H₉ or —OC₅H₁₁, more preferably a hydrogen atom, or a group represented by —CH₃, —C₂H₅, —OCH₃, —OC₂H₅, or —OC₃H₇.

The R⁵ represents a hydrogen atom (—H) or an optionally substituted alkyl group, preferably a hydrogen atom, or a group represented by —CH₃, —C₂H₅, —C₃H₇ or —C₄H₉, more preferably a hydrogen atom or a group represented by —CH₃.

Here, examples of a substituent that may be possessed by the alkylene group having 1 to 20 carbon atoms, the alkyl group having 1 to 20 carbon atoms, or the alkoxy group having 1 to 20 carbon atoms include a bromo group (—Br), a chloro group (—Cl), a fluoro group (—F), an iodo group (—I), a diazo group (═N₂), an azide group (—N₃), a nitro group (—NO₂), a carboxyl group (—COOH), an aldehyde group (—CHO), a cyano group (—CN), an acyl group (—COR), a thiol group (—SH), an amino group (—NH₂), and an imino group (═NH). This means that one or a plurality of hydrogen atoms possessed by the alkylene group having 1 to 20 carbon atoms, the alkyl group having 1 to 20 carbon atoms, or the alkoxy group having 1 to 20 carbon atoms may be substituted by these substituents.

The polymer compound has at least one structural unit selected from the group consisting of the above formulas (A) to (D), in a ratio of 30% by mol or more, more preferably 50% by mol or more with respect to the total structural units.

Examples of the polymer compound having a structural unit represented by the formula (A) include polyether polymers such as polyethylene oxide, polypropylene oxide, ethylene oxide-propylene oxide copolymer, ethylene oxide-alkylene oxide copolymer, ethylene oxide-methyl glycidyl ether copolymer, ethylene oxide-2-(2-methoxyethoxy)ethyl glycidyl ether copolymer, ethylene oxide-2-glycidoxy-1,3-bis(2-methoxyethoxy) propane copolymer, and ethylene oxide-propylene oxide copolymer diacrylate.

Examples of the polymer compound having a structural unit represented by the formula (B) include polyacrylic ester, and polymethacrylic ester. Examples of the polyacrylic ester include poly(methyl acrylate), poly(ethyl acrylate), poly(propyl acrylate), poly(isopropyl acrylate), poly(butyl acrylate), poly(isobutyl acrylate), poly(tertiary butyl acrylate), poly(pentyl acrylate), poly(methoxyethyl acrylate), poly(ethoxyethyl acrylate), poly(2-ethylhexyl acrylate), poly(2-hydroxyethyl acrylate), poly(2-hydroxypropyl acrylate), poly(dimethylaminoethyl acrylate), and poly(diethylaminoethyl acrylate). Examples of the polymethacrylic ester include poly(methyl methacrylate), poly(ethyl methacrylate), poly(propyl methacrylate), poly(isopropyl methacrylate), poly(butyl methacrylate), poly(isobutyl methacrylate), poly(tertiary butyl methacrylate), poly(pentyl methacrylate), poly(methoxyethyl methacrylate), poly(ethoxyethyl methacrylate), poly(2-ethylhexyl methacrylate), poly(2-hydroxyethyl methacrylate), poly(2-hydroxypropyl methacrylate), poly(dimethylaminoethyl methacrylate), and poly(diethylaminoethyl methacrylate).

Examples of the polymer compound having a structural unit represented by the formula (C) include polyacrylonitrile, acrylonitrile-methyl acrylate copolymer, acrylonitrile-ethyl acrylate copolymer, acrylonitrile-methyl methacrylate copolymer, acrylonitrile-ethyl methacrylate copolymer, acrylonitrile-vinyl acetate copolymer, acrylonitrile-butadiene copolymer, acrylonitrile-methyl acrylate-butadiene copolymer, acrylonitrile-ethyl acrylate-butadiene copolymer, and acrylonitrile-methyl methacrylate-butadiene copolymer.

Examples of the polymer compound having a structural unit represented by the formula (D) include poly(vinylidene fluoride), vinylidene fluoride-hexafluoropropylene copolymer, vinylidene fluoride-tetrafluoroethylene copolymer, vinylidene fluoride-hexafluoropropylene-tetrafluoroethylene copolymer, vinylidene fluoride-hexafluoropropylene-monomethyl maleate copolymer, and vinylidene fluoride-acrylonitrile copolymer.

The polymer compound has a weight-average molecular weight (hereinafter, also referred to as Mw) of preferably 1×10⁵ or more, more preferably 2×10⁵ or more. From the view point of the impregnating ability of the electrolyte solution to the electrodes, Mw is preferably 8×10⁶ or less, more preferably 4×10⁶ or less, further preferably 2×10⁶ or less, still further preferably 9×10⁵ or less. The weight-average molecular weight can be determined by gel permeation chromatography.

The polymer compound used in the electrolyte solution preferably has the same structural unit as that of the polymer compound used as a binder contained in a later-described negative electrode mixture. More preferably, it has the same main chain as that of the polymer compound used as a binder contained in the negative electrode mixture. Here, the main chain is the longest chain that forms the polymer compound. It is to be noted that the molecular weight of the polymer compound used as a binder is different from that of the polymer compound contained in the electrolyte solution. With the embodiment as described above, ion migration between the electrolyte solution and the negative electrode is facilitated, and the resistance is reduced.

### <Method for Preparing Electrolyte Solution>

The electrolyte solution used in the present invention is obtained by adding, stirring and dissolving a solvent, a sodium salt and a polymer compound. In the dissolving step, the electrolyte solution may be heated as is necessary, and is preferably heated at a temperature around the melting point of the polymer compound.

As other example of the method for preparing the electrolyte solution used in the present invention, a method of mixing a monomer having a structural unit represented by the formulas (A) to (D) together with the solvent and the sodium salt, and then polymerizing the monomer can be recited. As a method for polymerization, heat polymerization, electrolytic polymerization and the like can be recited.

For the purpose of improving the wettability with a separator, one or two or more surfactants such as trioctyl phosphate, diphenylether, ethyl octanoate, polyoxyethylene ethers having a perfluoroalkyl group, and perfluorooctane sulfonates may be added to the electrolyte solution. The adding amount of the surfactant is preferably 3% by weight or less, more preferably 0.01 to 1% by weight with respect to the total weight of the electrolyte solution.

### <Viscosity of Electrolyte Solution>

The viscosity of the electrolyte solution measured in the following condition (1) is preferably 10 mPa·s or more and 15000 mPa·s or less. From the viewpoint of the impregnating ability of the electrolyte solution to the electrodes, the viscosity is more preferably 6000 mPa·s or less, further preferably 4000 mPa·s or less, particularly preferably 2000 mPa·s or less. Furthermore, since the positive electrode, the separator, and the negative electrode are fixed and are likely to operate stably when the viscosity of the electrolyte solution is relatively high, the viscosity is more preferably 10 mPa·s or more, further preferably 30 mPa·s or more, still more preferably 50 mPa·s or more, particularly preferably 100 mPa·s or more.

### Condition (1)

In a viscometer, using a steel cone having a diameter of 40 mm and a cone angle of 4°, viscosity of the electrolyte solution when the steel cone is rotated for 40 seconds at a measurement environmental temperature of 23° C., at a shear rate of 30 sec⁻¹ is measured. As the viscometer, a stress rheometer (AR-550, available from TA Instruments) can be used.

From the view point of reducing the electrolyte solution leaking outside in case of breakage of the outer package of the battery, the ratio of the viscosity of the electrolyte solution measured in the following condition (1) to the viscosity in the following condition (2) (hereinafter, referred to as TI) is preferably larger than 1.0, more preferably larger than 1.1, and further preferably larger than 1.5.

### Condition (2)

In a viscometer, using a steel cone having a diameter of 40 mm and a cone angle of 4°, viscosity of the electrolyte solution when the steel cone is rotated for 40 seconds at a measurement environmental temperature of 23° C. and a shear rate of 100 sec⁻¹ is measured. As the viscometer, a stress rheometer (AR-550, available from TA Instruments) can be used.

### <Positive Electrode>

In the present invention, the positive electrode has a positive electrode active material that is doped and undoped with sodium ions. The positive electrode may be made up of a collector, and a positive electrode mixture containing the positive electrode active material carried on the collector. The positive electrode mixture contains a conductive material and/or a binder as is necessary besides the positive electrode active material as described above.

### <Positive Electrode Active Material>

In the present invention, the positive electrode active material is formed of a sodium-containing transition metal compound, and the sodium-containing transition metal compound is doped and undoped with sodium ions.

As the sodium-containing transition metal compound, the following compounds can be recited.

That is, oxides represented by NaM³ₐ₁O₂ such as NaFeO₂, NaMnO₂, NaNiO₂ and NaCoO₂, oxides represented by Na_{0.44}Mn₁₋ₐ₂M³ₐ₂O₂, oxides represented by Na_{0.7}Mn₁₋ₐ₂M¹ₐ₂O_{2.05} (M³ represents at least one transition metal element, 0<a1<1, 0≦a2<1);

oxides represented by Na_{b1}M⁴_{c}Si₁₂O₃₀ (M⁴ represents at least one transition metal element, 2≦b1≦6, 2≦c≦5) such as Na₆Fe₂Si₁₂O₃₀ and Na₂Fe₅Si₁₂O₃₀;

oxides represented by Na_{d}M⁵ₑSi₆O₁₈ (M⁵ represents at least one transition metal element, 2≦d≦6, 1≦e≦2) such as Na₂Fe₂Si₆O₁₈ and Na₂MnFeSi₆O₁₈;

oxides represented by Na_{f}M⁶_{g}Si₂O₆ (M⁶ represents at least one element selected from the group consisting of a transition metal element, Mg and Al, 1≦f≦2, 1≦g≦2) such as Na₂FeSiO₆

phosphates such as NaFePO₄, NaMnPO₄, Na₃Fe₂(PO₄)₃, Na₃V₂ (PO₄)₂F₃, Na_{1.5}VOPO₄F_{0.5}, Na₄Fe₃(PO₄)₂P₂O₇, Na₄Mn₃ (PO₄)₂P₂O₇, Na₄Ni₃ (PO₄)₂P₂O₇, and Na₄Co₃(PO₄)₂P₂O₇;

fluorophosphates such as Na₂FePO₄F, Na₂VPO₄F, Na₂MnPO₄F, Na₂COPO₄F, and Na₂NiPO₄F;

fluorosulfates such as NaFeSO₄F, NaMnSO₄F, NaCoSO₄F, and NaFeSO₄F;

borates such as NaFeBO₄, and Na₃Fe₂(BO₄)₃;

fluorides represented by NahM⁷F₆ (M⁷ represents at least one transition metal element, 2≦h≦3) such as Na₃FeF₆, Na₂MnF₆ (M⁷ represents at least one transition metal element, 2≦h≦3); and the like can be recited.

In the present invention, as the positive electrode active material, a composite metal oxide represented by the following formula (I) can be preferably used. With using the composite metal oxide represented by the following formula (I) as a positive electrode active material, it is possible to improve the charge/discharge capacity.

NaₐM¹_{b}M²O₂ (I)

(wherein, M¹ represents at least one element selected from the group consisting of Mg, Ca, Sr and Ba, M² represents at least one element selected from the group consisting of Mn, Fe, Co, Cr, V, Ti and Ni, a is a value in the range of 0.5 to 1.05 inclusive, b is a value in the range of 0 to 0.5 inclusive, and a+b is a value in the range of 0.5 to 1.10 inclusive.)

### <Conductive Material>

As the conductive material, a carbon material can be used. Examples of the carbon material include graphite powder, carbon black (e.g., acetylene black, Ketjen black, Furnace black, etc.), and fibrous carbon materials (carbon nanotube, carbon nanofiber, vapor phase grown carbon fiber, etc.). The carbon materials have the large surface area, and when they are added in a small amount into the electrode mixture, it is possible to improve the conductivity inside the obtained electrode, and to improve the charge/discharge efficiency and the heavy-current discharge characteristics. Normally, the proportion of the conductive material in the positive electrode mixture is 4 to 20 parts by weight with respect to 100 parts by weight of the positive electrode active material, and two or more kinds may be contained.

### <Binder>

Examples of the binder used in the positive electrode mixture include polymer compounds such as polymers of fluorine compounds, and addition polymers of monomers having an ethylenic double bond not containing a fluorine atom.

The glass transition temperature of the binder is preferably −50 to 25° C. By setting the glass transition temperature within this range, it is possible to improve the flexibility of the obtainable positive electrode, and to obtain a sodium secondary battery that is sufficiently usable under a low temperature environment.

Preferred examples of the binder used in the positive electrode mixture include

fluorine resins such as polytetrafluoroethylene, polychlorotrifluoroethylene, tetrafluoroethylene-perfluoroalkylvinyl ether copolymer, ethylene-tetrafluoroethylene copolymer, ethylene-chlorotrifluoroethylene copolymer, and tetrafluoroethylene-hexafluoropropylene copolymer;

fluorine rubbers such as vinylidene fluoride-hexafluoropropylene copolymer, vinylidene fluoride-tetrafluoroethylene copolymer, vinylidene fluoride-hexafluoropropylene-tetrafluoroethylene copolymer, vinylidene fluoride-pentafluoropropylene copolymer, vinylidene fluoride-pentafluoropropylene-tetrafluoroethylene copolymer, vinylidene fluoride-perfluoromethylvinyl ether-tetrafluoroethylene copolymer, and vinylidene fluoride-chlorotrifluoroethylene copolymer;

acrylic polymers such as polyacrylic acid, polyacrylic alkali salts (sodium polyacrylate, potassium polyacrylate, lithium polyacrylate, etc.), alkyl polyacrylate (the number of carbons in the alkyl moiety is 1 to 20), acrylic acid-alkyl acrylate (the number of carbons in the alkyl moiety is 1 to 20) copolymer, polyacrylonitrile, acrylic acid-alkyl acrylate-acrylonitrile copolymer, polyacrylamide, acrylonitrile-butadiene copolymer, and acrylonitrile-butadiene copolymer hydride;

methacrylic polymers such as polymethacrylic acid, alkyl polymethacrylate (the number of carbons in the alkyl moiety of the alkyl group is 1 to 20), and methacrylic acid-alkyl methacrylate copolymer;

polyether polymers such as polyethylene oxide, polypropylene glycol, polytetramethylene oxide, polyether sulfone, ethylene oxide-propylene oxide copolymer, and ethylene oxide-alkylene oxide copolymer;

olefinic polymers such as polyvinyl alcohol (partially saponificated or completely saponificated), ethylene-vinyl alcohol copolymer, polyvinylpyrrolidone, ethylene-vinyl acetate copolymer, ethylene-vinyl acetate-alkyl acrylate (the number of carbons in the alkyl moiety of the alkyl group is 1 to 20) copolymer, ethylene-methacrylic acid copolymer, ethylene-acrylic acid copolymer, ethylene-alkyl methacrylate copolymer, ethylene-alkyl acrylate copolymer, and ethylene-acrylonitrile copolymer; and

styrene-containing polymers such as acrylonitrile-styrene-butadiene copolymer, styrene-acrylonitrile copolymer, styrene-butadiene copolymer, and styrene-butadiene copolymer hydride.

In particular, use of a copolymer having a structural unit derived from vinylidene halide is preferred because an electrode having high density of the positive electrode mixture is easy to be obtained, and the volume energy density of the battery is improved.

The mixing proportion of the binder in the positive electrode mixture is normally 0.5 to 15 parts by weight, preferably 2 to 10 parts by weight with respect to 100 parts by weight of the positive electrode mixture.

### <Method for Producing Positive Electrode>

A positive electrode is produced, for example, by carrying a positive electrode mixture containing a positive electrode active material that is doped and undoped with sodium ions, on a positive electrode collector. As a method for carrying the positive electrode mixture on the positive electrode collector, for example, a method of preparing and kneading a positive electrode mixture paste composed of a positive electrode active material, a conductive material, a binder and a solvent, and applying the obtained positive electrode mixture paste on a collector, followed by drying can be recited. The method for applying the positive electrode mixture paste on the collector is not particularly limited. For example, a slit die coating method, a screen coating method, a curtain coating method, a knife coating method, a gravure coating method, an electrostatic spray method and the like methods can be recited. As drying conducted after application, a heat treatment may be employed, or air-blow drying, vacuum drying or the like may be employed. When drying by a heat treatment is employed, the temperature is normally about 50 to 150° C. Also, a press may be conducted after drying. As a method for the press, a die press, a roll press and the like methods can be recited. With the methods as described above, it is possible to produce an electrode. The thickness of the positive electrode mixture is normally about 5 to 500 μm.

As the solvent used in the positive electrode mixture paste, for example, organic solvents can be recited. The organic solvent may be any of a polar solvent or a nonpolar solvent. Examples of the polar solvent include amides such as N-methyl-2-pyrrolidone, N,N-dimethylacetamide, and dimethylformamide; alcohols such as isopropyl alcohol, ethyl alcohol, and methyl alcohol; ethers such as propylene glycol dimethylether; and ketones such as acetone, methylethyl ketone, and methylisobutyl ketone. Examples of the nonpolar solvent include hexane and toluene. Also as a solvent, water may be used, and water is preferred for preventing the production cost of the electrode.

The proportion of the positive electrode mixture ingredient in the positive electrode mixture paste, namely the proportion of the positive electrode active material, the conductive material and the binder in the positive electrode mixture paste is usually 40 to 70% by weight from the viewpoint of the thickness of the obtained electrode and the coating performance.

In the positive electrode, as the collector, a conductor such as Al, Ni or stainless can be recited, and Al is preferred in the point that it is easily processed into a thin film, and is low in price. Examples of the shape of the collector include a foil shape, a plate shape, a mesh shape, a net shape, a lath shape, a punching metal shape, and an embossed shaped, and combinations thereof (for example, meshed plate). Unevenness may be formed on the surface of the collector by an etching treatment.

As the positive electrode, the one that carries a polymer compound in the electrolyte solution can also be used. As a method for carrying the polymer compound on the positive electrode, for example, a method of adding the polymer compound to the positive electrode mixture paste, and applying the obtained paste on the collector, followed by drying can be recited. The mixing proportion of the polymer compound carried on the positive electrode obtained in this technique is usually 0.1 to 10 parts by weight, preferably 0.5 to 5 parts by weight with respect to 100 parts by weight of the positive electrode mixture.

As other method for carrying a polymer compound in the electrolyte solution on the positive electrode, a method of applying a polymer compound solution in which the polymer compound is dissolved in a solvent on the positive electrode that is obtained by applying the positive electrode mixture paste on the collector, followed by drying can be recited. As the solvent used in the polymer compound solution, solvents similar to those described as the solvent used in the positive electrode mixture paste can be recited. The method for applying the polymer compound solution on the positive electrode is not particularly limited and, for example, similar methods as those recited as the method for applying the positive electrode mixture paste to the collector can be recited. The mixing proportion of the polymer compound carried on the positive electrode obtained by the present technique is usually 0.1 to 10 parts by weight, preferably 0.5 to 5 parts by weight with respect to 100 parts by weight of the positive electrode mixture.

### <Method for Producing Positive Electrode Active Material>

A sodium-containing transition metal oxide, which is one of examples of the positive electrode active material, can be produced by firing a mixture of a metal-containing compound having such a composition that can become a sodium-containing transition metal oxide used in the present invention by firing. Specifically, it can be produced by weighing and mixing a metal-containing compound containing a corresponding metal element to have a predetermined composition, and then firing the obtained mixture. For example, a sodium-containing transition metal oxide having a metal element ratio represented by Na:Mn:Fe:Ni=1:0.3:0.4:0.3, which is one of preferred metal element ratios, can be produced by weighing the respective materials of Na₂CO₃, MnO₂, Fe₃O₄, and Ni₂O₃ so that the molar ratio of Na:Mn:Fe:Ni is 1:0.3:0.4:0.3, and mixing the weighed materials, and firing the obtained mixture. When the sodium-containing transition metal oxide contains M¹ (M¹ is at least one element selected from the group consisting of Mg, Ca, Sr and Ba), a material containing M¹ can be added at the time of mixing.

Examples of the metal-containing compound that can be used for producing the sodium-containing transition metal compound used in the present invention include oxides, and compounds that can become oxides when they are decomposed at high temperature and/or oxidized, for example, hydroxides, carbonates, nitrates, halides or oxalates. As the sodium compound, at least one compound selected from the group consisting of sodium hydroxide, sodium chloride, sodium nitrate, sodium peroxide, sodium sulfate, sodium bicarbonate, sodium oxalate and sodium carbonate can be recited, and also hydrates of these compounds can be recited. From the view point of the handleability, sodium carbonate is more preferred. As a manganese compound, MnO₂ is preferred, as an iron compound, Fe₃O₄ is preferred, and as a nickel compound, Ni₂O₃ is preferred. These metal-containing compounds may be hydrates.

A mixture of the metal-containing compound can be obtained by obtaining a precursor of the metal-containing compound, for example, by the following precipitation method, and mixing the obtained precursor of the metal-containing compound with the sodium compound.

Specifically, as a material of M² (here, M² has the same meaning as described above), a compound such as a chloride, a nitrate, an acetate, a formate, or an oxalate is used, and the compound is dissolved in water and brought into contact with a precipitator, and thus a precipitate containing the precursor of the metal-containing compound can be obtained. Among these materials, chlorides are preferred. Further, when a material that is difficult to be dissolved in water is used, namely, when an oxide, a hydroxide, or a metal material is used as a material, these materials may be dissolved in acid such as hydrochloric acid, sulfuric acid, or nitric acid, or aqueous solutions thereof, and an aqueous solution containing M may be obtained.

As the precipitator, at least one compound selected from the group consisting of LiOH (lithium hydroxide), NaOH (sodium hydroxide), KOH (potassium hydroxide), Li₂CO₃ (lithium carbonate), Na₂CO₃ (sodium carbonate), K₂CO₃ (potassium carbonate), (NH₄)₂CO₃ (ammonium carbonate) and (NH₂)₂CO (urea) can be used, at least one hydrate of these compounds may be used, and a compound and a hydrate may be used together. Preferably, the precipitator is dissolved in water, and used in the form of an aqueous solution. The concentration of the precipitator in the form of an aqueous solution is about 0.5 to 10 mol/L, preferably about 1 to 8 mol/L. Also it is preferred to use KOH as the precipitator, and more preferably, a KOH aqueous solution in which KOH is dissolved in water is used. As the precipitator in the form of an aqueous solution, also aqueous ammonia can be recited, and the aqueous ammonia and the aqueous solution of the compound may be used together.

As a method for bringing the aqueous solution containing M² into contact with the precipitator, a method of adding the precipitator (including the precipitator in the form of an aqueous solution) to the aqueous solution containing M², a method of adding the aqueous solution containing M² to the precipitator in the form of an aqueous solution, and a method of adding the aqueous solution containing M² and the precipitator (including the precipitator in the form of an aqueous solution) to water can be recited. Addition of these is preferably accompanied by stirring. Among the aforementioned methods for contacting, a method of adding the aqueous solution containing M² to the precipitator in the form of an aqueous solution is preferably used because pH is easily kept, and the grain size can be easily controlled. In this case, the pH tends to drop as the aqueous solution containing M² is added to the precipitator in the form of an aqueous solution. It is desired to add the aqueous solution containing M² while pH is adjusted to be 9 or more, preferably 10 or more. This adjustment can also be achieved by addition of the precipitator in the form of an aqueous solution.

By the contact as described above, it is possible to obtain a precipitate. The precipitate contains a precursor of the metal-containing compound.

Also, after the contact between the aqueous solution containing M² and the precipitator, usually, slurry is formed, and the slurry can be separated into solid and liquid, and the precipitate can be collected. The solid-liquid separation may be conducted in any method, and from the view point of the handleability, a method based on solid-liquid separation such as filtration is preferably employed, or alternatively a method of volatilizing the liquid by heating such as spray drying may be used. The collected precipitate may be washed or dried. Since the ingredient of the excess precipitator sometimes adheres to the precipitate obtained after solid-liquid separation, it is possible to reduce the ingredient by washing. As a washing liquid used in washing, water is preferably used, and a water-soluble organic solvent such as alcohol or acetone may be used. The drying can be conducted by heat drying, or may be conducted by air-blow drying, vacuum drying or the like. When the drying is conducted by heat drying, the drying is conducted normally at 50 to 300° C., preferably at about 100 to 200° C. The washing may be conducted two or more times.

While the mixing can be conducted by any of dry mixing and wet mixing, dry mixing is preferred from the view point of convenience. As the mixing device, stirring mixing, a V-type mixer, a W-type mixer, a ribbon mixer, a drum mixer and a ball mill can be recited. Firing can be usually conducted at a temperature, which depend on the kind of the used sodium compound, retained in the range of from about 400 to 1200° C., preferably at a temperature in the range of from about 500 to 1000° C. The time retained at the retained temperature is usually 0.1 to 20 hours, preferably 0.5 to 10 hours. The raising speed of temperature to the retained temperature is usually 50 to 400° C./hour, and the dropping speed of temperature to the room temperature from the retained temperature is usually 10 to 400° C./hour. As an atmosphere for firing, atmospheric air, oxygen, nitrogen, argon or mixed gas thereof can be used, and atmospheric air is preferred.

By using an appropriate amount of a halide or the like such as a fluoride or a chloride as a metal-containing compound, it is possible to control the crystallinity of the generated composite metal oxide, and the average particle diameter of particles constituting the composite metal oxide. In this case, the halide can occasionally function as a reaction promotor (flux). Examples of the flux include NaF, MnF₃, FeF₂, NiF₂, CoF₂, NaCl, MnCl₂, FeCl₂, FeCl₃, NiCl₂, CoCl₂, NH₄Cl and NH₄I, and an appropriate amount of these, as a material for the mixture (metal-containing compound), can be added to the mixture. These fluxes may be hydrates. Other examples of the metal-containing compound include Na₂CO₃, NaHCO₃B₂O₃ and H₃BO₃.

When the sodium-containing transition metal compound used in the present invention is used as a positive electrode active material for sodium secondary battery, it can be preferred to optionally conduct grinding for the sodium-containing transition metal compound obtained in the manner as described above, by using a device that is commonly and industrially used such as a ball mill, a jet mill, a vibrating mill, and to conduct washing, classification and the like, to adjust the grain size. Firing may be conducted two or more times. Also a surface treatment may be conducted so as to coat the grain surface of the sodium-containing transition metal compound with an inorganic substance containing Si, Al, Ti, Y or the like. In the case of conducting a heat treatment after the surface treatment, the BET specific surface area of the powder after the heat treatment is sometimes smaller than the range of the BET specific surface area before the surface treatment depending on the temperature of the heat treatment.

### <Sodium Secondary Battery of the Present Invention—Negative Electrode>

As the negative electrode that can be used in the sodium secondary battery of the present invention, an electrode in which a negative electrode mixture containing a negative electrode active material is carried on a negative electrode collector, or a sodium metal or sodium alloy electrode that can be doped or undoped with sodium ions can be used. As the negative electrode active material, besides the sodium metal or sodium alloy, carbon materials such as natural graphite, artificial graphite, cokes, carbon black, pyrocarbons, carbon fiber, fired organic polymer compounds, and metal that can be doped or undoped with sodium ions can be recited. The shape of the carbon material may be any of flakes represented by natural graphite, spheres represented by meso-carbon microbeads, fibers represented by graphitized carbon fibers, and an aggregate of fine powder. Here, the carbon material may function as a conductive material.

As a carbon material, nongraphitized carbon materials such as carbon black, pyrocarbons, carbon fiber, and fired organic materials (hereinafter, also referred to as hard carbon) can be recited. As the hard carbon, a hard carbon having an interlayer distance d by the X-ray diffraction method of 0.360 nm or more and 0.395 nm or less, and a size Lc of the crystalline in the c-axis direction of 1.30 nm or less are preferred. Also a hard carbon having an R value (ID/IG) calculated from the results of Raman spectroscopy of 1.07 or more and 3 or less are preferred. Here, R value (ID/IG) is obtained by dividing ID by IG, in a Raman spectrum obtained by conducting Raman spectrometry by irradiating with a laser beam having a wavelength of 532 nm (the vertical axis indicates scattered light intensity of an arbitrary unit the horizontal axis indicates a Raman shift wave number (cm⁻¹)), wherein in a fitting spectrum which is obtained by conducting a fitting using two Lorentz functions and one baseline function for a wave number range of 600 to 1740 cm⁻¹ of a spectrum having one peak in the range of 1300 to 1400 cm⁻¹ of the horizontal axis and in the range of 1570 to 1620 cm⁻¹ of the horizontal axis respectively, and removing the baseline function from the fitting function, the maximum value of the vertical axis in the range of the 1300 to 1400 cm⁻¹ is defined as ID, and the maximum value of the vertical axis in the range of the 1570 to 1620 cm⁻¹ is defined as IG, R value (ID/IG).

As the hard carbon, for example, carbon microbeads made of a non-graphitized carbon material can be recited, and specifically, ICB (product name: NICABEADS) available from Nippon Carbon Co., Ltd. can be recited. As the shape of the grains that form the carbon material, for example, flakes represented by natural graphite, spheres represented by meso-carbon microbeads, fibers represented by graphitized carbon fibers, and an aggregate of fine powder can be recited. When the shape of grains constituting the carbon material is spherical, the average grain diameter is preferably 0.01 μm or more and 30 μm or less, more preferably 0.1 μm or more and 20 μm or less.

Specific examples of the metal that is used in the negative electrode active material include tin, lead, silicon, germanium, phosphorus, bismuth, and antimony. Examples of the alloy include alloys composed of two or more metals selected from the group of metals as described above, alloys composed of two or more metals selected from the group of metals as described above and transition metals, and alloys such as Si—Zn, Cu₂Sb, and La₃Ni₂Sn₇. These metals and alloys are carried on the collector together with the carbon material, and used as an electrode active material.

Examples of the oxide used in the negative electrode active material include Li₄Ti₅O₁₂, and Na₂Ti₃O₇. Examples of the sulfide include TiS₂, NiS₂, FeS₂, and Fe₃S₄. Examples of the nitride include Na₃₋ₓMₓN such as Na₃N, Na_{2.6}Co_{0.4}N (M represents a transition metal element, 0≦x≦3).

The carbon material, metal, oxide, sulfide, and nitride which are negative electrode active materials may be used together, and they may be crystalline or noncrystalline. From the view point of cycle characteristics, as the negative electrode active material, a carbon material is preferably used, and hard carbon is more preferably used.

These carbon material, metal, oxide, sulfide and nitride are mainly carried on a collector, and used as an electrode.

The negative electrode mixture may contain a binder and a conductive material. As the binder and the conductive material, those similar to those used in the positive electrode mixture can be recited.

As the binder contained in the negative electrode mixture, those identical to the polymer compounds recited for the positive electrode can be used. Preferred examples include polyacrylic acid, sodium polyacrylate, lithium polyacrylate, potassium polyacrylate, polyethylene oxide, polypropylene oxide, ethylene oxide-propylene oxide copolymer, ethylene oxide-alkylene oxide copolymer, carboxymethyl cellulose, hydroxymethyl cellulose, hydroxyethyl cellulose, hydroxypropyl cellulose, ethylene-vinyl acetate copolymer, styrene-butadiene copolymer, polyvinylidene fluoride, polytetrafluoroethylene, vinylidene fluoride-hexafluoropropylene copolymer, vinylidene fluoride-tetrafluoroethylene copolymer, and vinylidene fluoride-hexafluoropropylene-tetrafluoroethylene copolymer. More preferably, those swelling in the electrolyte solution are recited, and examples include polyethylene oxide, polypropylene oxide, ethylene oxide-propylene oxide copolymer, ethylene oxide-alkylene oxide copolymer, polyvinylidene fluoride, vinylidene fluoride-hexafluoropropylene copolymer, vinylidene fluoride-tetrafluoroethylene copolymer, and vinylidene fluoride-hexafluoropropylene-tetrafluoroethylene copolymer. These may be used solely or in combination of two more kinds.

The polymer compound used as a binder contained in the negative electrode mixture preferably has the same structural unit as the polymer compound used for the electrolyte solution as described above.

The proportion of the binder in the negative electrode mixture is usually 0.5 to 20 parts by weight, preferably 1 to 15 parts by weight, more preferably 2 to 12 parts by weight with respect to 100 parts by weight of the negative electrode mixture.

As the solvent used in the negative electrode mixture paste, those identical to the solvents used in the positive electrode mixture paste can be recited.

As a negative electrode collector, Al, Cu, Ni and stainless can be recited, and Al is preferred in the point that it is easily processed into a thin film, and is low in price. Examples of the shape of the collector include a foil shape, a plate shape, a mesh shape, a net shape, a lath shape, a punching metal shape, and an embossed shaped, and combinations thereof (for example, meshed plate). Unevenness may be formed on the surface of the collector by an etching treatment.

As the negative electrode, a negative electrode which carries a polymer compound in the electrolyte solution can also be used. As a method for carrying the polymer compound on the negative electrode, for example, a method of adding the polymer compound to the negative electrode mixture paste, and applying the obtained paste on the collector, followed by drying can be recited. The mixing proportion of the polymer compound carried on the negative electrode obtained in this technique is usually 0.1 to 15 parts by weight, preferably 0.5 to 12 parts by weight with respect to 100 parts by weight of the negative electrode mixture.

As other method for carrying a polymer compound in the electrolyte solution on the negative electrode, a method of applying a polymer compound solution in which the polymer compound is dissolved in a solvent, on the negative electrode that is obtained by applying the negative electrode mixture paste on the collector, followed by drying is recited. As the solvent used in the polymer compound solution, solvents identical to those recited as the solvent used in the negative electrode mixture paste can be recited. Although the method for applying the polymer compound solution on the negative electrode is not particularly limited, for example, methods identical to those recited as the method for applying the negative electrode mixture paste to the collector can be recited. As the mixing proportion of the polymer compound carried on the negative electrode obtained by the present technique is normally 0.1 to 10 parts by weight, preferably 0.5 to 5 parts by weight with respect to 100 parts by weight of the negative electrode mixture.

### <Sodium Secondary Battery of the Present Invention—Separator>

As a separator that can be used in the sodium secondary battery of the present invention, for example, a material in the form of a porous film, nonwoven fabric, woven fabric or the like, made of polyolefin resins such as polyethylene or polypropylene, fluorine resin, nitrogen-containing aromatic polymer or the like can be used. Also, a single-layered or laminated separator using two or more of these materials is applicable. As a separator, for example, separators described in JP-A-2000-30686, JP-A-10-324758 and so on can be recited. The thickness of the separator is preferably as small as possible as long as the mechanical strength is kept in the point that the volume energy density of the battery increases and the internal resistance decreases. Generally, the thickness of the separator is preferably about 5 to 200 μm, more preferably about 5 to 40 μm.

The separator preferably has a porous film containing a thermoplastic resin. In a secondary battery, it is normally important to interrupt the current and prevent the excessive current from flowing (to shut down) when abnormal current flows in the battery due to a short circuit between the positive electrode and the negative electrode or the like. Therefore, the separator is requested to shut down at as low as possible temperature when the normal use temperature is exceeded (to occlude the micropores of the porous film when the separator has a porous film containing thermoplastic resin), and to keep the shutdown state even when the internal temperature of the battery rises to some degree of high temperature after the shutdown without being broken due to the temperature, or in other words, to have high heat resistance. By using a separator having a laminated porous film in which a heat-resistant porous layer containing a heat-resistant resin, and a porous film containing a thermoplastic resin are laminated, as the separator, it becomes possible to further prevent the heat breakage of the film of the secondary battery of the present invention. Here, the heat-resistant porous layer may be laminated on both faces of the porous film.

As the separator, the one carrying the polymer compound in the electrolyte solution may be used. As a method for carrying the polymer compound on the separator, a method of applying a polymer compound solution in which the polymer compound is dissolved in a solvent, on the separator, followed by drying is recited. As the solvent used in the polymer compound solution, those identical to the solvents used in the negative electrode mixture paste can be recited. While the method for applying the polymer compound solution on the separator is not particularly limited, for example, methods identical to those recited as the method for applying the negative electrode mixture paste to the collector can be recited. The proportion of the polymer compound carried on the separator obtained by the present technique is normally 20 to 300 parts by weight, preferably 50 to 200 parts by weight with respect to 100 parts by weight of the separator.

### EXAMPLES

Hereinafter, the present invention will be described more specifically by way of examples. Evaluation of a sodium-containing transition metal compound and hard carbon, and measurement of viscosity of an electrolyte solution were conducted by the following measurements.

### 1. Powder X-Ray Diffraction Measurement of Sodium-Containing Transition Metal Compound and Hard Carbon

Powder X-ray diffraction measurement of a sodium-containing transition metal compound was conducted by using type RINT2500TTR available from Rigaku Corporation. A special holder was charged with a sodium-containing transition metal compound, and measurement was conducted with a diffraction angle 2θ ranging from 10 to 90° by using a CuKα radiation source, to obtain a powder X-ray diffraction graphic. For hard carbon, a powder X-ray diffraction graphic was obtained in the same manner as described above.

### 2. Composition Analysis of Sodium-Containing Transition Metal Compound

After dissolving powder in hydrochloric acid, measurement was conducted by using inductively coupled plasma-atomic emission spectroscopy (available from SII, SPS3000, hereinafter, also referred to as ICP-AES).

### 3. Measurement of Viscosity of Electrolyte Solution

Using a stress rheometer (AR-550, available from TA Instruments) attached with a steel cone having a diameter of 40 mm and cone angle of 4°, viscosity of the electrolyte solution when the steel cone was rotated for 40 seconds at a shear rate of 30 sec⁻¹, at a measurement environmental temperature of 23° C. was measured. Sequentially, viscosity at a shear rate of 100 sec⁻¹ was also measured in the same manner.

### Production Example 1

### Composite Metal Oxide A1 and Production of Positive Electrode AE1

In a polypropylene beaker, 44.88 g of potassium hydroxide was added to 300 mL of distilled water, and dissolved by stirring to completely dissolve potassium hydroxide, and thus a potassium hydroxide aqueous solution (precipitator) was prepared. In another polypropylene beaker, 21.21 g of iron (II) chloride tetrahydrate, 19.02 g of nickel chloride (II) hexahydrate, and 15.83 g of manganese chloride (II) tetrahydrate were added to 300 mL of distilled water, and dissolved by stirring to obtain an iron-nickel-manganese-containing aqueous solution. By adding the iron-nickel-manganese-containing aqueous solution dropwise to the precipitator under stirring, a slurry in which a precipitate was formed was obtained. Then the slurry was filtered and washed with distilled water, and dried at 100° C. to obtain a precipitate. After weighing the precipitate, sodium carbonate and calcium hydroxide so that Fe:Na:Ca was 0.4:0.99:0.01 by molar ratio, they were dry-mixed in an agate mortar to obtain a mixture. Then the mixture was put into a firing vessel made of alumina, and firing was conducted by retaining in an air atmosphere at 850° C. for 6 hours by using an electric furnace, and then the mixture was cooled to room temperature to obtain composite metal oxide A¹. Powder X-ray diffraction analysis conducted for the composite metal oxide A¹ revealed the attribution to α-NaFeO₂ type crystal structure. As a result of analysis of the composition of the composite metal oxide A¹ by ICP-AES, the molar ratio of Na:Ca:Fe:Ni:Mn was 0.99:0.01:0.4:0.3:0.3. Then using the composite metal oxide A¹ obtained in the manner as described above, acetylene black as a conductive material, vinylidene fluoride-tetrafluoroethylene copolymer as a binder solution, and NMP as a solvent, a positive electrode mixture paste was prepared. Weighing was conducted so that the composition of composite metal oxide A¹:conductive material:binder:NMP was 90:5:5:100 (weight ratio), and they were mixed by stirring at 4,000 rpm for 5 minutes by using a Dispermat (available from VMA-GETZMANN) to obtain a positive electrode mixture paste. The obtained positive electrode mixture paste was applied on aluminum foil having a thickness of 20 μm by using a doctor blade, and dried for 2 hours at 60° C., and then rolled at a pressure of 200 kN/m by using a roll press (SA-602, available from TESTER SANGYO CO., LTD.) to obtain a positive electrode AE1.

### Production Example 2

### Carbon Material C¹ and Production of Carbon Electrode CE¹

ICB (Product name: NICABEADS) available from Nippon Carbon Co., Ltd. was introduced into a firing furnace, and the interior of the furnace was brought into an argon gas atmosphere, and then the temperature was raised from the room temperature to 1600° C. at a rate of 5° C./min. while an argon gas was circulated at a rate of 0.1 L/g (weight of carbon material) per minute, then the temperature was retained at 1600° C. for 1 hour, and then cooled to obtain carbon material C¹. Powder X-ray diffraction measurement of the carbon material C¹ revealed that the interlayer distance d (002) was 0.368 nm, and the size Lc of the crystal in the c-axial direction was 1.17 nm. Also it was revealed that R value (ID/IG) obtained by Raman spectroscopy was 1.41. An electrode mixture paste was prepared using the carbon material C¹, polyvinylidene fluoride (available from KUREHA CORPORATION, KF polymer W#1300, hereinafter, referred to as PVdF-2.) as a binder, and NMP (available from KISHIDA CHEMICAL Co., Ltd.) as a solvent. Weighing was conducted so that the composition of carbon material C¹:PVdF-2:NMP was 90:10:100 (weight ratio), and they were stirred and mixed by using a Dispermat (available from VMA-GETZMANN) to obtain an electrode mixture paste. The rotating condition of the rotating blade was 2,000 rpm for 10 minutes. The obtained electrode mixture paste was applied on copper foil by using a doctor blade, dried at 60° C. for 2 hours, and then rolling at 100 kN/m was conducted by using a roll press to give carbon electrode CE1.

### Example 1

### Production of Sodium Secondary Battery BP1

To 1.0 mol/L of NaPF₆/propylene carbonate solution (1.0 M NaPF₆ PC) (available from KISHIDA CHEMICAL Co., Ltd.), polyethylene oxide (PEO) of Mw=100,000 (available from Johnson Matthey) was added in a weight ratio of 98.0:2.0, and stirred and dissolved under heating at 60° C. to prepare a nonaqueous electrolyte solution ELP¹ (0.98 M NaPF₆ PC/2.0% by weight PEO). In a recess of a lower part of a coin cell (available from Hohsen Corp.), a positive electrode AE¹ punched into a diameter of 14.5 mm was placed, and a sodium secondary battery BP1 was produced by using a carbon electrode CE¹ punched into a diameter of 15.0 mm as a negative electrode, the nonaqueous electrolyte solution ELP¹ as an electrolyte solution, and a polyethylene porous film (thickness 20 μm) as a separator. The battery was assembled in an argon atmosphere in a glove box.

### Example 2

### Production of Sodium Secondary Battery BP²

To 1.0 M NaPF₆ PC, PEO was added in a weight ratio of 96.3:3.7, and stirred and dissolved under heating at 60° C. to prepare a nonaqueous electrolyte solution ELP² (0.96 M NaPF₆ PC/3.7% by weight PEO). A sodium secondary battery BP² was produced in the same manner as in Example 1 except that the nonaqueous electrolyte solution ELP² was used as an electrolyte solution.

### Example 3

### Production of Sodium Secondary Battery BP³

1.3 mol/L of NaPF₆/propylene carbonate solution (1.3 M NaPF₆ PC) (available from KISHIDA CHEMICAL Co., Ltd.), PC, and PEO were added in a weight ratio of 78:12:10, and stirred and dissolved under heating at 60° C. to prepare a nonaqueous electrolyte solution ELP³ (0.99 M NaPF₆ PC/10% by weight PEO). A sodium secondary battery BP³ was produced in the same manner as in Example 1 except that the nonaqueous electrolyte solution ELP³ was used as an electrolyte solution.

### Example 4

### Production of Sodium Secondary Battery BP⁴

To 1.0 M NaPF₆ PC, PVdF (available from KUREHA CORPORATION, KF polymer W#9100, hereinafter, referred to as PVdF-1.) was added in a weight ratio of 99.5:0.5, and stirred and dissolved under heating at 150° C. to prepare a nonaqueous electrolyte solution ELP⁴ (0.99 M NaPF₆ PC/0.5% by weight PVdF-1). A sodium secondary battery BP⁴ was produced in the same manner as in Example 1 except that the nonaqueous electrolyte solution ELP⁴ was used as an electrolyte solution.

### Example 5

### Production of Sodium Secondary Battery BP⁵

To 1.0 M NaPF₆ PC, PVdF-1 was added in a weight ratio of 98.0:2.0, and stirred and dissolved under heating at 150° C. to prepare a nonaqueous electrolyte solution ELP⁵ (0.99 M NaPF₆ PC/2.0% by weight PVdF-1). A sodium secondary battery BP⁵ was produced in the same manner as in Example 1 except that the nonaqueous electrolyte solution ELP⁵ was used as an electrolyte solution.

### Example 6

### Production of Sodium Secondary Battery BP⁶

To 1.0 M NaPF₆ PC, PVdF-1 was added in a weight ratio of 96.3:3.7, and stirred and dissolved under heating at 150° C. to prepare a nonaqueous electrolyte solution ELP⁶ (0.97 M NaPF₆ PC/3.7% by weight PVdF-1). A sodium secondary battery BP⁶ was produced in the same manner as in Example 1 except that the nonaqueous electrolyte solution ELP⁶ was used as an electrolyte solution.

### Example 7

### Production of Sodium Secondary Battery BP⁷

To 1.0 M NaPF₆ PC, PVdF (available from KUREHA CORPORATION, KF polymer W#1300) was added in a weight ratio of 96.3:3.7, and stirred and dissolved under heating at 150° C. to prepare a nonaqueous electrolyte solution ELP⁷ (0.97 M NaPF₆ PC/3.7% by weight PVdF-2). A sodium secondary battery BP⁷ was produced in the same manner as in Example 1 except that the nonaqueous electrolyte solution ELP⁷ was used as an electrolyte solution.

### Example 8

### Production of Sodium Secondary Battery BP⁸

To 1.0 M NaPF₆ PC, vinylidene fluoride-hexafluoropropylene copolymer (available from ARKEMA, KYNAR FLEX 2750-01, hereinafter, referred to as PVdF-HFP-1.) was added in a weight ratio of 98.0:2.0, and stirred and dissolved under heating at 150° C. to prepare a nonaqueous electrolyte solution ELP⁸ (0.99 M NaPF₆ PC/2.0% by weight PVdF-HFP-1). A sodium secondary battery BP⁸ was produced in the same manner as in Example 1 except that the nonaqueous electrolyte solution ELP⁸ was used as an electrolyte solution.

### Example 9

### Production of Sodium Secondary Battery BP⁹

To 1.0M NaPF₆ PC, PVdF-HFP-1 was added in a weight ratio of 96.3:3.7, and stirred and dissolved under heating at 150° C. to prepare a nonaqueous electrolyte solution ELP⁹ (0.97 M NaPF₆ PC/3.7% by weight PVdF-HFP-1). A sodium secondary battery BP⁹ was produced in the same manner as in Example 1 except that the nonaqueous electrolyte solution ELP⁹ was used as an electrolyte solution.

### Example 10

### Production of Sodium Secondary Battery BP¹⁰

To 1.0 M NaPF₆ PC, vinylidene fluoride-hexafluoropropylene copolymer (available from ARKEMA, KYNAR FLEX 2800-00, hereinafter, referred to as PVdF-HFP-2.) was added in a weight ratio of 96.3:3.7, and stirred and dissolved under heating at 150° C. to prepare a nonaqueous electrolyte solution ELP¹⁰ (0.97 M NaPF₆ PC/3.7% by weight PVdF-HFP-2). A sodium secondary battery BP¹⁰ was produced in the same manner as in Example 1 except that the nonaqueous electrolyte solution ELP¹⁰ was used as an electrolyte solution.

### Comparative Example 1

### Production of Sodium Secondary Battery BH¹

A sodium secondary battery BH¹ was produced in the same manner as in Example 1 except that 1.0 M NaPF₆ PC was used as a nonaqueous electrolyte solution.

### Comparative Example 2

### Production of Sodium Secondary Battery BH²

1.3 M NaPF₆ PC, and PEO were added in a weight ratio of 80:20, and stirred and dissolved under heating at 60° C. to prepare a nonaqueous electrolyte solution HLP¹ (1.0 M NaPF₆ PC/20% by weight PEO). A sodium secondary battery BH² was produced in the same manner as in Example 1 except that the nonaqueous electrolyte solution HLP¹ was used as an electrolyte solution.

### <Charge-Discharge Test>

Prior to conducting a charge-discharge test, an operation for stabilizing actuation of the sodium secondary batteries BP¹ to BP¹⁰, BH¹, and BH² were conducted (stabilizing operation), and then an output test and a charge-discharge cycle test were conducted.

### <Stabilizing Operation>

An electrification operation including CC charging at a 0.05 C rate (the speed with which the battery is fully charged for 20 hours) from the rest potential up to 3.2 V, followed by CC (constant current) discharging down to 2.0 V at a 0.1 C rate (the speed with which the battery is fully charged for 10 hours) was conducted one cycle. Further, an electrification operation including CC charging at a 0.05 C rate up to 3.8 V, followed by CC discharging down to 2.0 V at 0.1 C rate was conducted one cycle. Sequentially, an electrification operation including CC-CV charging (charging ends when 0.005 C current value was reached) at a 0.05 C rate up to 4.0 V, followed by CC discharging down to 2.0 V at 0.1 C rate was conducted one cycle. In addition, an electrification operation including CC-CV charging at a 0.1 C rate up to 4.0 V (charging ends when 0.02 C current value was reached), followed by CC discharging down to 2.0 V at 0.2 C rate was conducted three cycles.

### <Output Test>

After the stabilizing operation, the output test was conducted in the following conditions. After conducting CC-CV charging at a 0.2 C rate up to 4.0 V (charging ends when 0.02 C current value was reached), CC discharging down to 2.0 Vat 0.2 C rate was conducted. Then an output test was conducted in the same charging condition as described above, while the discharging current was set at 0.5, 1, 2, 5, or 10 C rate. Table 1 shows a ratio of 5 C discharge capacity to 0.2 C discharge capacity (5 C discharge capacity/0.2 C discharge capacity×100(%)) as output characteristics.

### <Charge-Discharge Cycle Test>

After the output test, a charge-discharge cycle test was conducted in the following conditions. A charge-discharge test including CC-CV charging at a 0.2 C rate (charging ends when 0.02 C current value was reached) up to 4.0V, followed by CC discharging at a 0.2 C rate down to 2.0 V was conducted. Then a charge-discharge test including CC charging at a 1 C rate up to 4.0V, followed by CC discharging at a 0.5 C rate down to 2.0 V was conducted 49 cycles. Lastly, a charge-discharge test including CC-CV charging at a 0.2 C rate (charging ends when 0.02 C current value was reached) up to 4.0V, followed by CC discharging at a 0.2 C rate down to 2.0 V was conducted. Table 1 shows a retained percentage of discharge capacity before and after the charge-discharge cycle test (0.2 C discharge capacity after cycle test/0.2 C discharge capacity before cycle test×100(%)) as cycle characteristics.

TABLE 1

| | | | Highly | | | Output | Cycle |
|---|---|---|---|---|---|---|---|
| | | Polymer | dielectric | | | character- | character- |
| | Polymer | compound | solvent | Viscosity | Viscosity | istics | istics |
| | compound | (% by weight) | (% by weight) | (30 s⁻¹) | (100 s⁻¹) | (%) | (%) |
| Example 1 | PEO | 2.0 | 85 | 40 | 40 | 47.9 | 71.3 |
| Example 2 | PEO | 3.7 | 84 | 73 | 74 | 32.7 | 79.0 |
| Example 3 | PEO | 10.0 | 77 | 431 | 423 | 15.6 | 37.3 |
| Example 4 | PVdF-1 | 0.5 | 87 | 11 | 10 | 61.2 | 81.1 |
| Example 5 | PVdF-1 | 2.0 | 85 | 185 | 78 | 56.3 | 73.1 |
| Example 6 | PVdF-1 | 3.7 | 84 | 250 | 135 | 59.8 | 92.0 |
| Example 7 | PVdF-2 | 3.7 | 84 | 1262 | 428 | 48.9 | 91.7 |
| Example 8 | PVdF-HFP-1 | 2.0 | 85 | 91 | 51 | 57.2 | 84.8 |
| Example 9 | PVdF-HFP-1 | 3.7 | 84 | 300 | 139 | 49.0 | 82.6 |
| Example 10 | PVdF-HFP-2 | 3.7 | 84 | 299 | 133 | 42.9 | 79.5 |
| Comparative | — | — | 87 | 6 | 6 | 8.9 | 36.8 |
| Example 1 | | | | | | | |
| Comparative | PEO | 20.0 | 77 | 2728 | 2558 | 7.2 | 41.9 |
| Example 2 | | | | | | | |

As shown in Table 1, the usefulness of the present invention was confirmed. In addition, the sodium battery of the present invention is relatively excellent also in cycle characteristics.

### Production Example 3

### Carbon Material C¹ and Production of Carbon Electrode CE²

An electrode mixture paste was prepared by using the carbon material C¹ of Production example 2, carboxymethyl cellulose (hereinafter, referred to as CMC) (available from DKS Co. Ltd., CELLOGEN 4H) and styrene-butadiene rubber (hereinafter, referred to as SBR) (available from NIPPON A & L INC., AL3001) as a binder, and pure water as a solvent. These materials were weighed so that the composition of carbon material C1:CMC:SBR was 97:2:1 (weight ratio), and they were stirred and mixed by using a Dispermat (available from VMA-GETZMANN) to obtain an electrode mixture paste. The rotating condition of the rotating blade was 2,000 rpm, for 10 minutes. The obtained electrode mixture paste was applied on copper foil by using a doctor blade, dried at 60° C. for 2 hours, and then rolling at 100 kN/m was conducted by using a roll press to give carbon electrode CE².

### Example 11

### Production of Sodium Secondary Battery BP¹¹

A sodium secondary battery BP¹¹ was produced in the same manner as in Example 10 except that the carbon electrode CE² punched into a diameter of 15.0 mm was used as a negative electrode.

### Comparative Example 3

### Production of Sodium Secondary Battery BH³

A sodium secondary battery BH³ was produced in the same manner as in Comparative Example 1 except that the carbon electrode CE² punched into a diameter of 15.0 mm was used as a negative electrode.

### <Charge-Discharge Test>

After conducting an operation for stabilizing actuation of the sodium secondary batteries BP¹¹, BH³ (stabilizing operation), an output test and a charge-discharge cycle test were conducted. The conditions of the stabilizing operation, the conditions of the output test, and the conditions of the charge-discharge cycle test are identical to those described above. Table 2 shows a ratio of 5 C discharge capacity to 0.2 C discharge capacity (5 C discharge capacity/0.2 C discharge capacity×100(%)) as output characteristics, and a retained percentage of discharge capacity after the charge-discharge cycle test (0.2 C discharge capacity after cycle test/0.2 C discharge capacity before cycle test×100(%)) as cycle characteristics.

TABLE 2

| | | | Highly | | | Output | Cycle |
|---|---|---|---|---|---|---|---|
| | | Polymer | dielectric | | | character- | character- |
| | Polymer | compound | solvent | Viscosity | Viscosity | istics | istics |
| | compound | (% by weight) | (% by weight) | (30 s⁻¹) | (100 s⁻¹) | (%) | (%) |
| Example 11 | PVdF-HFP-2 | 3.7 | 84 | 299 | 133 | 26.0 | 31.6 |
| Comparative | — | — | 87 | 6 | 6 | 21.4 | 29.0 |
| Example 3 | | | | | | | |

As shown in Table 2, the usefulness of the present invention was confirmed. In addition, the sodium battery of the present invention is relatively excellent also in cycle characteristics.

1. A sodium secondary battery comprising a positive electrode having a positive electrode active material that is doped and undoped with sodium ions, a negative electrode having a negative electrode active material that is doped and undoped with sodium ions, and an electrolyte solution containing a solvent, a sodium salt and a polymer compound, wherein the electrolyte solution contains the polymer compound in an amount ranging from 0.1% by weight to 18% by weight to the electrolyte solution.

2. The sodium secondary battery according to claim 1, wherein the electrolyte solution contains at least one nonaqueous solvent selected from the group consisting of ethylene carbonate, propylene carbonate, sulfolane, γ-butyrolactone, and fluoroethylene carbonate within a range of 40% by weight or more and 90% by weight or less to the electrolyte solution.

3. The sodium secondary battery according to claim 1, wherein the polymer compound is a polymer compound containing at least one structural unit selected from the group consisting of the following formulas (A) to (D): 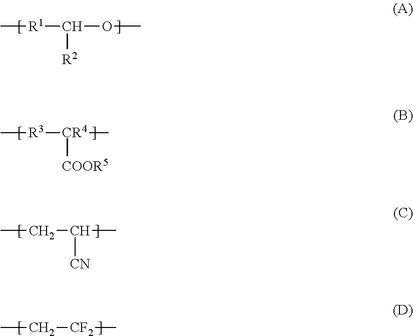
wherein, R¹ and R³ each independently represents an optionally substituted alkylene group having 1 to 20 carbon atoms, R² and R⁴ each independently represents a hydrogen atom, a hydroxyl group, an optionally substituted alkyl group having 1 to 20 carbon atoms, or an optionally substituted alkoxy group having 1 to 20 carbon atoms, and R⁵ represents a hydrogen atom or an optionally substituted alkyl group having 1 to 20 carbon atoms.

4. The sodium secondary battery according to claim 1, wherein a viscosity of the electrolyte solution measured in the following condition (1) is 10 mPa·s or more and 15000 mPa·s or less:
Condition (1):
in a viscometer, using a steel cone having a diameter of 40 mm and a cone angle of 4°, viscosity of the electrolyte solution when the steel cone is rotated for 40 seconds at a measurement environmental temperature of 23° C., at a shear rate of 30 sec⁻¹ is measured.

5. The sodium secondary battery according to claim 1, wherein the negative electrode has a negative electrode active material and a binder, and the negative electrode active material is hard carbon.

6. The sodium secondary battery according to claim 1, wherein the positive electrode has a positive electrode active material, a conductive material and a binder, and the positive electrode active material is represented by the following formula (I):
NaₐM¹_{b}M²O² (I)
wherein, M¹ represents at least one element selected from the group consisting of Mg, Ca, Sr and Ba, M² represents at least one element selected from the group consisting of Mn, Fe, Co, Cr, V, Ti and Ni, a is a value in the range of 0.5 to 1.05, b is a value in the range of 0 to 0.5, and a+b is a value in the range of 0.5 to 1.10.
